(19) United States
(12) Patent Application Publication
(10) Pub. No.: US 2011/0246251 A1
(43) Pub. Date: Oct. 6, 2011

(54) METHOD AND SYSTEM FOR PROVIDING CONTENT-BASED INVESTIGATION SERVICES

(75) Inventors: Donald E. Saunders, Carrollton, TX (US); Robert J. Reynolds, Carrollton, TX (US); David R. Moyer, Euless, TX (US)

(73) Assignee: VERIZON PATENT AND LICENSING INC., Basking Ridge, NJ (US)

(21) Appl. No.: 12/753,512

(22) Filed: Apr. 2, 2010

(51) Int. Cl. G06Q 10/00; G06F 17/30; G06F 15/16

(52) U.S. Cl. 705/7.12; 707/687; 709/224; 707/748; 707/E17.007; 707/E17.084

(57) ABSTRACT

An approach is provided for content-based investigation services. Event data corresponding to content satisfying a predetermined criterion is received. A plurality of prioritization parameters relating to the content are retrieved. One or more of the prioritization parameters are selected based on the received event data. A prioritization score for the event data is generated using the selected parameters. Inspection of the event data is scheduled according to the prioritization score. A determination is selectively made whether the content is in violation according to the inspection.

### BACKGROUND INFORMATION

Network based content inspection is increasingly becoming an integral part of monitoring the access and exchange of network data associated with a number of activities, such as cyber surveillance, content access control, network traffic monitoring, antivirus protection, anti-spamming implementation, content annotation, content caching, and the like. Unfortunately, conventional approaches to monitoring, assessing, and reporting about network use based on violations to predetermined content policies are limited. For instance, these approaches typically focus on blocking access to objectionable content, but provide little in the way of policing and investigating the exchange of content through, for example, electronic mail, chat-based, and other communication systems. Moreover, these systems provide little in the way of eliminating false-positive violations, and thus, can be more disruptive in terms of use of resources.

Therefore, there is a need for an approach that can provide more efficient and effective content-based investigation services.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system configured to provide content-based investigation services, according to an exemplary embodiment;

FIG. 2 is a diagram of a content inspection platform configured to facilitate content-based investigation services, according to an exemplary embodiment;

FIG. 3 is a flowchart of a process for generating event data corresponding to content satisfying at least one content-based criterion, according to an exemplary embodiment;

FIG. 4 is a flowchart of a process to facilitate content-based investigation services, according to an exemplary embodiment;

FIG. 5 is a flowchart of a process for generating a ticket corresponding to a suspected content-based violation, according to an exemplary embodiment;

FIG. 6 is a flowchart of a process for generating a prioritization score for scheduling investigation of a suspected content-based violation, according to an exemplary embodiment;

FIG. 7 is a flowchart of a process for generating an alert for initiating investigation of a suspected content-based violation and/or generating a ticket review request, according to an exemplary embodiment;

FIG. 8 is a flowchart of a process for reviewing a ticket and/or generating an alert for initiating investigation of a suspected content-based violation, according to an exemplary embodiment;

FIG. 9 is a flowchart of a process for modifying a ticket based on results of a ticket review, according to an exemplary embodiment;

FIG. 10 is a flowchart of a process for requesting more information concerning a suspected content-based violation and/or closing a ticket associated with the suspected content-based violation, according to an exemplary embodiment;

FIG. 11 is a flowchart of a process for updating a ticket associated with a request for more information concerning a suspected content-based violation, according to an exemplary embodiment;

FIG. 12 is a flowchart of a process for modifying one or more content-based monitoring parameters in response to determining that particular event data relates to a false-positive suspected content-based violation, according to an exemplary embodiment;

FIG. 13 is a diagram of a computer system that can be used to implement various exemplary embodiments; and

FIG. 14 is a diagram of a chip set that can be used to implement various exemplary embodiments.

### DESCRIPTION OF THE PREFERRED EMBODIMENT

A preferred apparatus, method, and software for providing content-based investigation services are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a content inspection platform having a centralized architecture, it is contemplated that these embodiments have applicability to any architecture (e.g., distributed).

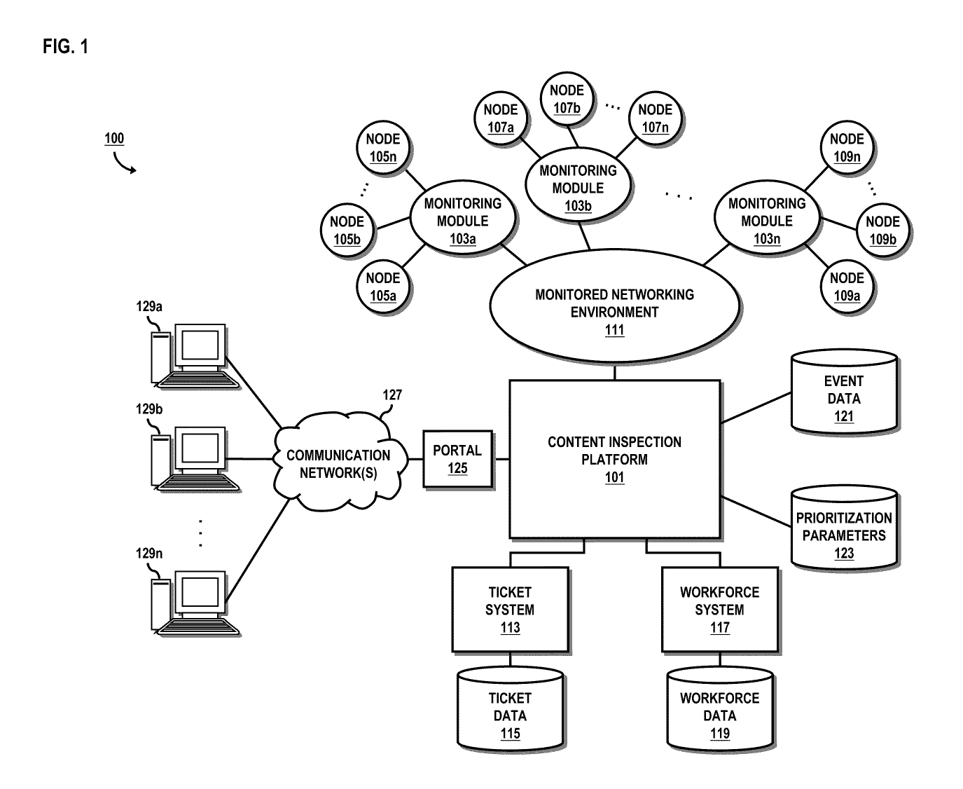

FIG. 1 is a diagram of a system configured to provide content-based investigation services, according to an exemplary embodiment. For illustrative purposes, system 100 is described with respect to content inspection platform (or platform) 101 configured to receive event data from, for instance, one or more monitoring modules 103a-103n corresponding to content satisfying one or more predetermined criteria, the content having been accessed or exchanged by one or more nodes 105a-105n, 107a-107n, 109a-109n via monitored networking environment (or environment) 111. In certain embodiments, content can include various digital media, e.g., textual data, audio data, video data, or a combination thereof, in any format (e.g., data stream, binary files, Moving Picture Experts Group (MPEG) file, Joint Photographic Experts Group (JPEG) file, Tagged Image File Format (TIFF), HyperText Markup Language (HTML), etc.). Platform 101 may be further configured to retrieve one or more prioritization parameters relating to the content and, based on the received event data, select one or more of the retrieved prioritization parameters for generating a prioritization score for the event data. Generated prioritization scores may be utilized to schedule the investigation of suspected violations of one or more content-based policies and/or rules. While specific reference will be made hereto, it is contemplated that system 100 may embody many forms and include multiple and/or alternative components and facilities.

According to certain embodiments, the platform 101 can advantageously provide a platform to view, inspect, update, and/or analyze events to identify and report incidents. The monitoring modules 103a-103n in communication with the platform 101 can monitor the network of, for example, nodes 105a-109n based on one or more predetermined content-based criterion. Monitoring the network provides the capability of determining whether any suspected content-based violations have occurred. According to certain embodiments, if the monitored networking environment 111 and/or the platform 101 determines that monitored data and/or content satisfies at least one of predetermined criteria, the platform 101 can generate event data corresponding to the data and/or the content that satisfied the predetermined content-based criteria. The generated event data can be used for content-based investigation in order to, for example, determine necessary actions needed to be taken in response to the event data. Also, according to one example, similar and/or related event data, actions taken in response to the event data, etc., can be correlated to each other such that an incident is generated.

According to certain embodiments, the generated event data can be stored in event data database 121. The event data can further be retrieved for content-based inspection analysis and/or investigation. According to certain embodiments, the generated event data can be used to generate tickets used, for example, for maintaining workflow information such as, but not limited to, status, escalation, and notification associated with the suspected content-based violation. Accordingly, the platform 101 in communication with ticket system 113 can generate the ticket for the event data such that content investigation and reporting can be performed. According to certain embodiments, the platform 101 in communication with the ticket system 113 can use prioritization parameters stored in, for example, prioritization parameters database 123 to generate the prioritization score for the generated ticket for, for example, investigation scheduling purposes.

In exemplary embodiments, monitoring modules 103a-103n monitors network traffic associated with environment 111. Monitoring may be performed over any suitable time interval, which may be predefined and/or configured by, for example, a network administrator. For instance, a configurable time interval may be established for monitoring network traffic over several seconds, minutes, hours, days, etc. Further, the configurable time interval may be subdivided into a plurality of configurable subintervals. That is, the network administrator may provision a time granularity for the configurable time interval that can enable monitoring modules 103a-103n to analyze content-based aspects of network traffic at various temporal “grains” of the configurable time interval. In certain embodiments, time granulations may be on the order of one or more seconds, deciseconds, centiseconds, milliseconds, microseconds, nanoseconds, etc. It is noted that as the configurable time interval becomes more granular, traffic abstraction and aggregation can be reduced so that monitoring modules 103a-103n may detect and analyze more “temporal,” yet significant bursts of network traffic.

According to particular embodiments, monitoring modules 103a-103n may be configured to receive input from “mirroring” ports of nodes 105a-109n. It is noted that “mirroring” ports enable transmitted units of data received by nodes 105a-109n to be mirrored (or copied) to a memory of or accessible to monitoring modules 103a-103n for preliminary content-based analysis, e.g., initial determination of suspected content-based violations. As such, monitoring modules 103a-103n may intercept, mirror, and/or log various forms of network traffic information. This information may correlate to network traffic that a client has (or attempted to) access or exchange via environment 111.

In general, a transmitted unit of data is received at monitoring modules 103a-103n in a particular format including, for instance, a “header” and a “payload.” Headers typically provide supplemental information concerning information (e.g., content) to be accessed or transported via environment 111, while payloads carry the “random” information (e.g., content) accessed or submitted for transportation via environment 111. According to certain embodiments, traffic information (or event data) generated or obtained by monitoring modules 103a-103n can be information extracted from (or generated based on) the headers of transmitted units of data. This header information may include various information, such as addressing information (e.g., a source of a unit of data, a destination for a unit of data, a preferred transport route, etc.), service related information (e.g., classifications of units of data relating to data, voice, and/or video services, etc.), length (or size) information, timestamp information, and the like. It is noted that this header information may be generally categorized as metadata about or related to a transmitted unit of data and, therefore, need not be specified in the headers themselves. As such, header information may be parsed (or copied) from and/or generated based on the headers of actual (or mirrored) network traffic and may be stored using any suitable structuring technique, such as a relational table, hierarchical tree, networked model, etc. According to certain other embodiments, traffic information (or event data) generated or obtained by monitoring modules 103a-103n can be information extracted from (or generated based on) the payloads of transmitted units of data. This payload information may include various information

According to exemplary embodiments, monitoring modules 103a-103n transmit (or otherwise provide) network traffic information, i.e., event data, to platform 101 for further analysis, investigative prioritization, and facilitation of content-based investigations. In various embodiments, this transmission of event data to platform 101 may be performed in real-time (i.e., as the event data is generated or collected), on a periodic basis (e.g., after a predetermined time period, such as at the conclusion of one or more subintervals, or the conclusion of a configurable time interval, etc.), or in an “on-demand” fashion (e.g., when requested by, for instance, platform 101, a network administrator, etc.).

According to exemplary embodiments, platform 101 may also communicate with ticket system 113, either directly or via one or more networks (such as a corporate network of a service provider of system 100), to initiate and/or obtain information about suspected, content-based violations. Tickets may be utilized to document and aggregate evidence concerning suspected, content-based violations and, as such, may relate to or include “work orders,” such as gathering more evidence, determining whether event data relates to a false-positive, tuning monitoring modules 103a-103n, etc. As such, ticket system 113 is configured to accept information from various internal resources (e.g., analyst, monitoring modules 103a-103n, platform 101, etc.), as well as from external resources (e.g., customers) regarding suspected, content-based violations related to (or otherwise implicating) environment 111. This information may be utilized to generate one or more tickets. Alternatively, ticket system 113 may accept tickets generated by the internal or external resources and/or modifications thereto. In the aggregate, these tickets define an investigative workload, which is and assigned to analyst and prioritized via platform 101 based on event data corresponding to content satisfying one or more content-based criteria (or rules) and selection of one or more prioritization parameters relating to the content. Accordingly, ticket system 113 may include one or more mechanisms to monitor and maintain workflow elements related to the investigation of suspected, content-based violations, such as one or more modules for monitoring and managing incident status, escalation, and notification. That is, ticket system 113 may be configured as an operations support system that provides platform 101 and/or investigators with a unified view of the investigative workload associated with environment 111, however, ticket data may be segregated at any granularity to represent the workload as it corresponds to various issues before, after, or during the investigation of suspected, content-based violations.

Ticket system 113 may be implemented as any suitable interface, such as a conventional call center, an interactive voice response (IVR) unit, a web-based graphical user interface (GUI), and/or any other equivalent or combinatory user interface, for generating and/or receiving tickets/ticket data. For instance, a user may initiate a communication session with an IVR implementation of ticket system 113 via a plain old telephone service device and provide verbal input concerning a suspected, content-based violation detected by one or more of monitoring modules 103a-103n. In response thereto, ticket system 113 may generate an electronic record, i.e., a ticket, documenting the issue, as well as append to the record other information, such as the aforementioned header and/or payload information, i.e., the various forms of event data corresponding to satisfying one or more predetermined criteria. Ticket system 113 may also include a workflow engine that generates tickets based on event data and/or requests received from, for instance, platform 101 and/or monitoring modules 103a-103n, that is associated with detected or otherwise suspected, content-based violations. Ticket system 113 may also receive prioritization scores, false-positive data, and/or other statistics. As such, ticket system 113 may include this additional information in a ticket. Further, ticket system 113 may receive and/or track ticket status messages, such as a current stage of an investigation or resolution thereof, generated by, for example, workforce system 117, and include this information in a ticket. According to one example, the workforce system 117 can store and/or retrieve ticket status message from a database, such as workforce data database 119.

According to certain exemplary embodiments, ticket system 113 and/or platform 101 may be configured to notify analysts and/or investigators when a suspected, content-based violation (or incident) occurs via one or more generated tickets and/or notifications. It is noted that exemplary notifications may include (or otherwise specify) initial information corresponding to a suspected incident, which may be utilized to prioritize and guide investigations. In certain embodiments, platform 101, portal 125, and/or ticket system 113 may provide a user interface by which notification recipients can locate tickets that may include details and/or sensitive information specific to a suspected, content-based violation.

According to one embodiment, ticket system 113 may be configured to structure and/or compartmentalize ticket information into various fields, tables, and/or other suitable structures, such as delimited text files. For example, a ticket data structure may include columns and rows that correspond to particular data fields and data entries, respectively. In any case, a data structure may be propagated with data entries corresponding to ticket information for the purpose of facilitating content-based investigations. Alternatively, data structures may be generated automatically. It is noted that the aforementioned data structures are merely exemplary and are not intended to limit the nature or structure of a data source that may be utilized by the various components and/or facilities of system 100.

Thus, by way of example, ticket system 113 can generate tickets including data (or information), such as, but not limited to, information regarding a category of the event, priority information, a ticket number, details of the event, etc. According to certain embodiments, the detailed information of the suspected, content-based violations included in the ticket can contain information regarding the identities and/or addresses of the suspected, content-based violators (e.g., IP addresses, usernames, e-mail addresses, etc.), timing information of suspected, content-based violations, number of occurrences, a detailed discussion of the events, any attachments, etc.

According to particular embodiments, ticket system 113 stores generated and/or received tickets to ticket data repository 115, which may be utilized to store information regarding content-based investigations corresponding to environment 111. Additionally (or alternatively), tickets may be stored to a memory of ticket system 113 and/or transmitted to platform 101. As such, ticket system 113 also includes a communication interface (not shown) configured to transmit tickets and/or ticket information to platform 101, either “on-demand” or as the result of a predefined schedule, such as continuously, randomly, or periodically, e.g., after expiration of a predetermined time period. Platform 101 may in turn include received ticket information (or parse tickets for particular ticket information), which may then be ported into an application, data store, module, etc., to facilitate content-based investigations.

According to certain embodiments, when event data associated with the content satisfying one or more of the predetermined content-based criteria is generated, the platform 101 and/or the ticket system 113 can determine whether a ticket for the event data already exists in, for example, the ticket data database 115. In one example, platform 101 and/or the ticket system 113 can retrieve the event data from, for example, the event data database 121, and can initiate a process for generating the ticket if no ticket already exists for the event data and the event data has value and/or a desired result. According to certain embodiments, the process for creating a ticket can include initiating presentation of a user interface (UI) that can include plurality of options for characterizing the suspected content-based violation for the ticket. In one example, an analyst can interact with the UI and one or more ticket field can be populated based, at least in part, on the interaction of the analyst with the UI. Additionally or alternatively, event data can be used to populate ticket fields. Further, a ticket number such as a tracking number can be assigned to the ticket, which can be used to track movements and evolutions of the ticket. According to certain embodiments, the generated ticket with the tracking number can be stored in the ticket data database 115.

The generated ticket can be analyzed to investigate the suspected content-based violation. According to certain embodiments, the investigation scheduling of created tickets can be advantageously be performed in accordance with the prioritization score. Accordingly, one or more prioritization parameters associated with the content of the event data can be retrieved from, for example, the prioritization parameters database 123, based, at least in part, on the event data and/or its associated ticket, one or more of the retrieved prioritization parameters can be selected, and the prioritization score can be generated for the ticket. According to certain embodiments, the platform 101 and/or the ticket system 113 can determine the prioritization score and can assign the prioritization score to the ticket.

According to certain embodiments, the ticket with the prioritization score can be further reviewed by different levels of authorities. In one example, ticket status messages, such as a current stage of an investigation or resolution thereof, generated by, for example, workforce system 117, can be retrieved from, for example, the workforce data database 119. In one example, the retrieved workforce information can determine general information regarding the stage of creation and review of the ticket, for example, which authority has, for example initiated the ticket creation and which authority has reviewed the ticket. According to certain embodiments, a ticket initiate by an analyst can be transmitted to a reviewer analyst to further review the ticket for quality, completeness, etc. According to this exemplary embodiment, the reviewer analyst can determine whether any revision and/or modification are needed for the ticket. If needed, a checklist of the revisions can be generated, can be assigned to the ticket, and can be transmitted to the analyst for further revisions. The analyst can initiate the need modifications and initiate generation of another review request. The process of the review and revision can be repeated until the issues are resolved. It is contemplated that the review and revision process can occur in different levels of authorities in the system.

According to exemplary embodiments, the generated ticket that passes the process of the review and revision can be transmitted for external investigation, for example, by customers. In on example, when the platform 101 and/or the ticket system 113 determines that the generated ticket does not need more review and modification, the ticket can be transmitted, for example, to one or more of the user devices 129a-129n for external investigation of the suspected content-based violation. According to an embodiment, it is determined whether information of the tickets is sufficient to resolve the ticket. If the information is sufficient, the ticket can be resolved and can be closed. However, if not sufficient information exist to resolve the ticket, according to one example, the platform 101 and/or the ticket system 113 can initiate a request for more information related to the suspected content-based violation. In one example, the platform 101 and/or the ticket system 113 can search the event data database 121 and/or the ticket data database 115 to determine whether more information is available. Additionally or alternatively, the monitored networking environment 111 can be inquired to collect more information regarding the suspected violation. The ticket can be update based on retrieved information and (after possible review and revision process) the updated ticket can be transmitted for external content-based investigation.

According to certain embodiments, the platform 101 can communication with the user devices 129a-129n through the communication network 127 (and/or the platform 125). In one example one or more of the user devices 129a-129n can be used by, for example, analysts, reviewers, etc., to initiate creation of, access, modify, and/or review event data, tickets, incident reports, etc., for, for example, internal content-based investigation of suspected content-based violations. Additionally or alternatively, one or more of the user devices 129a-129n can be used by, for example, customers, to access and review, for example, incident reports for external investigation of the suspected content-based violations.

Also, the communication network 127 may include one or more networks such as a data network and/or a telephony network. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. Moreover, the telephony network can be provided via a combination of circuit-switched technologies or a packetized voice infrastructure.

For the purpose of illustration, the communication network 127 can include a radio network that supports a number of wireless terminals, which may be fixed or mobile, using various radio access technologies. According to one exemplary embodiment, radio technologies that can be contemplated include: first generation (1G) technologies (e.g., advanced mobile phone system (AMPS), cellular digital packet data (CDPD), etc.), second generation (2G) technologies (e.g., global system for mobile communications (GSM), interim standard 95 (IS-95), etc.), third generation (3G) technologies (e.g., code division multiple access 2000 (CDMA2000), general packet radio service (GPRS), universal mobile telecommunications system (UMTS), etc.), 4G, etc. For instance, various mobile communication standards have been introduced, such as first generation (1G) technologies (e.g., advanced mobile phone system (AMPS), cellular digital packet data (CDPD), etc.), second generation (2G) technologies (e.g., global system for mobile communications (GSM), interim standard 95 (IS-95), etc.), third generation (3G) technologies (e.g., code division multiple access 2000 (CDMA2000), general packet radio service (GPRS), universal mobile telecommunications system (UMTS), etc.), and beyond 3G technologies (e.g., third generation partnership project (3GPP) long term evolution (3GPP LTE), 3GPP2 universal mobile broadband (3GPP2 UMB), etc.).

Complementing the evolution in mobile communication standards adoption, other radio access technologies have also been developed by various professional bodies, such as the Institute of Electrical and Electronic Engineers (IEEE), for the support of various applications, services, and deployment scenarios. For example, the IEEE 802.11 standard, also known as wireless fidelity (WiFi), has been introduced for wireless local area networking, while the IEEE 802.16 standard, also known as worldwide interoperability for microwave access (WiMAX) has been introduced for the provision of wireless communications on point-to-point links, as well as for full mobile access over longer distances. Other examples include Bluetooth, ultra-wideband (UWB), the IEEE 802.22 standard, etc.

According to certain embodiments, the platform 101 can further be configured to determine whether the event data, which is generated based, at least in part, on the content satisfying one or more predetermined content-based criteria, is false positive. In one example, the determination can include an inspection of the event data to verify if the event data is valid and/or can contain valuable results. However, if the platform 101 determines that the event data is false positive and a ticket already exists for the event, the platform 101 can initiate a process for tuning collection modules, such as monitoring modules 103a-103n. According to an embodiment, the platform 101 can determine one or more parameters for tuning and/or modifying the monitoring modules 103a-103n and can initiate transmission of the one or more determined parameters to the monitoring module 103a-103n via, for example, the monitored networking environment 111. In one example, the platform 101 and/or the ticket system 113 can close the ticket after the request for tuning is transmitted to the collection modules.

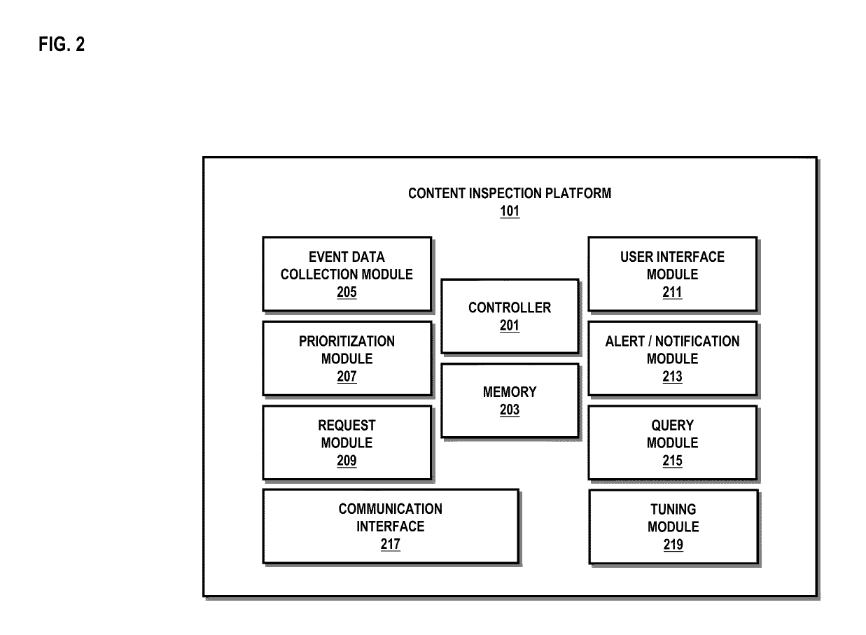

FIG. 2 is a diagram of a content inspection platform (the platform) configured to facilitate content-based investigation services, according to an exemplary embodiment. It is contemplated that the functions of these components may be combined in one or more components or performed by other components of equivalent functionality. In this embodiment, the platform 101 can include at least a controller 201 or other control logic and a memory 203 for executing at least one algorithm for performing the functions of the platform 101.

According to an exemplary embodiment, the controller 201 in communication event data collection module 205 can interact with the monitored networking environment 111 and/or the event data database 121 of FIG. 1 to collect, generate, modify, retrieve, and/or store the event data. According to certain embodiments, the event collection module 205 (in communication with, for example, the controller 201 and/or the communication interface 217) can interact with the monitored networking environment 111 of FIG. 1 to received data associated with the content satisfying one or more of the predetermined content-based criteria. In one example, the event data collection module 205 can use the collected data to generate the event data and (in communication with, for example, the communication interface 217) can store the generated event data in the event data database 121. Additionally or alternatively, the event data collection module 205 can (for example in communication with communication interface 217) further interact with the event data database 121 of FIG. 1 to retrieve an event data for, for example, ticket creation, quality inspection, investigation purposes, modification, etc.

According to certain exemplary embodiments, the platform 101 can include a prioritization module 207. In one example, the prioritization module 207 can interact with the ticket system 113 of FIG. 1 using, for example, a request module 209, to receive a request for the prioritization score for a ticket. Accordingly, the prioritization module 207 (in communication with the communication interface 217 and/or the query module 215) can interact with the prioritization parameters database 123 to retrieve one or more prioritization parameters relating to the content of the ticket for which the prioritization score is requested. According to one example, the prioritization module 207 (in communication with, for example, the event data collection module 205) can select one or more prioritization parameters from the retrieved parameters based, at least in part, on the event data associated with the ticket. Further, according to an exemplary embodiment, the prioritization module 207 can generate the prioritization score for the ticket using the selected parameters. In one example, the prioritization module 207 can assign the generated prioritization score to the ticket and can initiate transmission of the ticket to the ticket system 113 of FIG. 1 and/or can initiate storage of the ticket in, for example, the ticket data database 115.

According to certain embodiments, the platform 101 can include user interface (UI) module 211. In one example, the UI module 211 (in communication with, for example, the communication interface 217) can initiate presentation of a UI to a user, such as, an analyst, an analyst reviewer, a customer, etc. According to certain embodiments, the UI module 211 can interact with the ticket system 113 to present a UI, which can be used for creating of a ticket associated with an event data. In an example, the UI can include a plurality of options for characterizing the suspected content-based violation. Accordingly, the UI module 211 (in communication with the communication interface 217) can receive data related to the options provided by the UI and can provide the received data to, for example, the ticket system 113 to populate one or more ticket fields. Alternatively or additionally, the UI module 211 can initiate presentation of a UI to an analyst and/or an analyst reviewer to provide a platform to review different fields of the ticket and/or to make necessary modification. According to certain embodiments, the UI module 211 can provide a UI to, for example, a customer to provide a platform for the customer to review a ticket, event data, and/or an incident and perform necessary content-based investigation.

Additionally, the platform 101 can include alert/notification module 213. The alert/notification module 213 (and, for example, in communication with the communication interface 217) can be used to generate and initiate transmission of alert and/or notification messages. According to an exemplary embodiment, the alert/notification module 213 can generate alert messages used for internal and/or external content-based investigation of a ticket, event data, and/or an incident. In one example, the generated alert and/or notification messages can be used in accordance with other components of the platform 101. Additionally or alternatively the alert and/or notification messages can be transmitted to other components of the system 100 of FIG. 1. According to an exemplary embodiment, the platform 101 can also include the query module 215 for, for example, accessing the event data database 121, the prioritization parameters database 123, the ticket data database 115, and/or the workforce data database 119.

Also, according to certain embodiments, the platform 101 can include the tuning module 219, which can provide a platform for tuning collection modules. According to an exemplary embodiment, the ticketing system 113 and/or the platform 101 (for example, using controller 201) can determine a ticket and/or an event data associated with the ticket are not valid and/or do not include a desired result (for example, a false positive). In one example, the tuning module 219 can receive a request (from example, from the ticket system 113 and/or the request module 209) for tuning collection modules (such as one or more of the monitoring module 103a-103n). Accordingly, the tuning module 219 can determine one or more parameters for tuning and/or modifying of, for example, one or more of the monitoring modules 103a-103n. Further, in one example, the tuning module 219 can use the determined parameters to generate (for example in accordance with the request module 209) a tuning request to be transmitted to one or more of the monitoring modules 103a-103n.

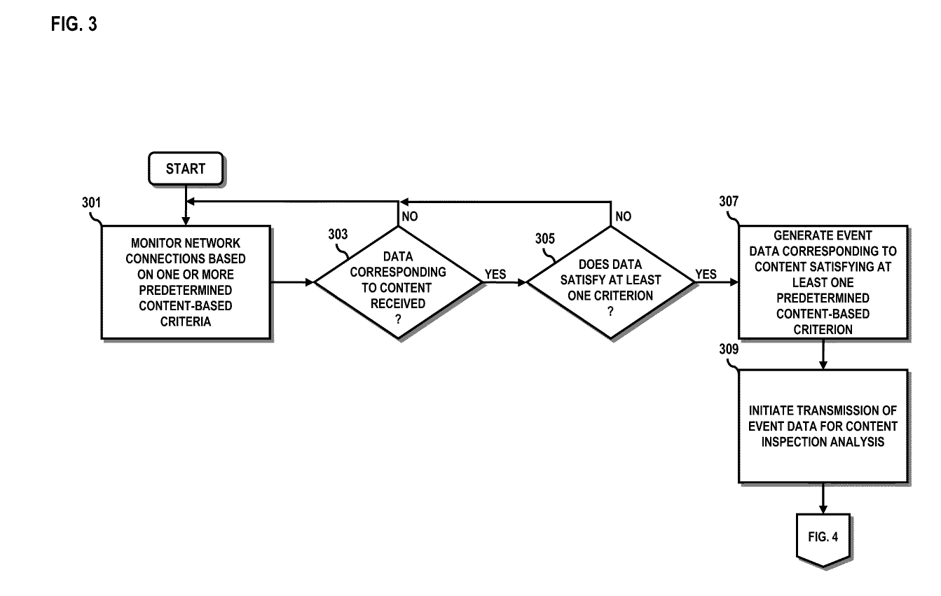

FIG. 3 is a flowchart of a process for generating event data corresponding to content satisfying at least one content-based criterion, according to an exemplary embodiment. For illustrative purposes, the process is described with respect to FIG. 1. It is noted that the steps of the process may be performed in any suitable order or combined in any suitable manner. At step 301, monitoring modules 103a-103n monitor network connections over environment 111 based on one or more predetermined content-based criteria. It is noted that these network connections are associated with one or more client nodes, such as nodes 105a-109n. According to exemplary embodiments, monitoring modules 103a-103n are configured to monitor various networking communications, such as networking communications associated with activity with particular characteristics (e.g., project names, textual phrases, destination/source addresses, etc.), transmission of company's proprietary information (e.g., source code), electronic mail activity, webmail activity, chat activity, instant messaging activity, peer-to-peer activity, file transfer activity, vulnerability assessment tool activity, password cracking tools activity, brute force activity, uniform resource locator based activity, online browser based activity, network mapping activity, enumeration activity, stack smashing activity, backdoor activity, key logging activity, sniffing activity, hacking activity, cracking activity, root activity, log wiping activity, installation activity, remote access and/or control activity, virtual network computing activity, researching activity associated with impermissible activity, communication of credit card information, personally identifiable information, and social security information, pornographic content access activity, proxy usage, multiple shell access activity, operating system root access activity, and the like. Exemplary activities are described in more detail in association with Tables 1-4. It is further noted that communications associated with monitored activities may be communications local to environment 111, communications that affect the infrastructure of environment 111, or communications that implicate at least one of client nodes 105a-109n.

In step 303, a determination is made if any data corresponding to content is received. The process continues to monitor the system if no data corresponding to the content is received. However, if the data corresponding to the content is received, in step 305, a determination is made whether the data corresponds to any predetermined content-based criteria. If the content does not satisfy the criteria, the monitoring modules 103a-103n continue to monitor the system. However, if the content data satisfies at least one criterion, in step 307, an event data is generated. According to one exemplary embodiment, the generated event data corresponds to the content that satisfies at least one of the predetermined content-based criteria. In step 309, the generated event is transmitted for content inspection analysis. According to certain embodiments, the generated event can be stored in the event database 121 such that it can also be accessed based on on-demand basis.

TABLE 1
“Critical” Priority Content-Based Violations

| | Default | |
|---|---|---|
| Named Violation | Priority | Description |
| Business Support | 1 | Custom designed content-based violation focusing on detecting |
| Category | | particular type(s) of content-based network traffic having (or being |
| | | associated with) particular characteristics, e.g., project names, |
| | | textual phrases, destination/source addresses, etc. |
| Proprietary Source Code | 1 | Detected transmission of a company's proprietary source code. |
| COBOL | | Excludes HyperText Transfer Protocol (HTTP) response. Detection |
| C and C++ | | should focus on proprietary source code leaving the company. |
| Perl | | |
| Visual Basic | | |
| Proprietary or Sensitive | 1 | Detected instances of outgoing web-based electronic mail that |
| Information sent via | | transmits proprietary or sensitive information to an unauthorized |
| Webmail | | end-user. Uploading of file attachments that contain proprietary or |
| | | sensitive information to a web-based electronic mail account is also |
| | | detected. |
| Unauthorized vulnerability | 1 | Detected output of a UNIX or Windows based vulnerability |
| assessment scan | | assessment tool. Detection should focus on assessment results |
| | | leaving the company. |
| Unauthorized packet | 1 | Detected output of packet “sniffing” software. Unauthorized packet |
| sniffer | | sniffers may detect user names and passwords that may put the |
| | | company at risk. Detection should focus on sniffer result |
| | | information leaving the company. |
| Server and Web | 1 | Detected use of vulnerability exploitation tools. Use of tool may |
| Vulnerability exploitation | | allow unauthorized users to exploit vulnerabilities putting the |
| tools | | company at risk. Detection should focus on tool result information |
| | | leaving the company |
| Password crackers and | 1 | Detected transfer of resulting data of password cracking tools, or |
| Brute force attacks | | brute force activity. Both activities are often associated with hacker |
| | | activities and put the company at risk. Detection should focus on |
| | | tool result information leaving the company. |
| Windows Operating | 1 | Detected activity associated with unauthorized Windows Operating |
| System Enumeration tools | | System Enumeration tools. Typically this network activity is |
| | | associated with attackers or hacker activity assessing systems in |
| | | search of vulnerabilities. |
| Unauthorized installation | 1 | Detected elements on a system that allow unauthorized control or |
| of operating system | | manipulation of an operating system. Detection should focus on |
| backdoor tools | | activity in which the source is outside the company. |

TABLE 2
“High” Priority Content-Based Violations

| | Default | |
|---|---|---|
| Named Violation | Priority | Description |
| Unauthorized access or | 2 | Detected transmission of credit card |
| transmission of Credit | | numbers in combination with |
| Card Information | | expiration dates, security codes, |
| | | access codes, or passwords that allow |
| | | access to corresponding financial |
| | | information. Detection should focus |
| | | on unencrypted information leaving |
| | | the company. |
| Unauthorized access or | 2 | Detected communications of |
| transmission Personally | | personal information, such as first |
| Identifiable Information | | and last name, home addresses, |
| (PII) | | mother's maiden names, driver's |
| | | license numbers, etc. Detection |
| | | should focus on unencrypted PII |
| | | leaving the company. |
| Unauthorized access or | 2 | Detected transmission of federal |
| transmission of federal | | social security number(s) in clear |
| Social Security Number | | text communication. Detection |
| | | should focus on unencrypted Social |
| | | Security Numbers leaving the |
| | | company. |

TABLE 3
“Medium” Priority Content-Based Violations

| | Default | |
|---|---|---|
| Named Violation | Priority | Description |
| Access of Pornographic | 3 | Detected access of “pornographic” |
| content | | content over networked environment. |
| Unauthorized proxy | 3 | Detected client-based access of a |
| usage | | unauthorized proxy device. Detection |
| | | should focus on activity in which |
| | | the source of the activity is internal |

TABLE 4
“Low” Priority Content-Based Violations

| | Default | |
|---|---|---|
| Named Violation | Priority | Description |
| Multiple failed FTP | 4 | Detected suspicious file transfer protocol |
| access attempts | | (FTP) failed attempts. Detection should |
| | | focus on failed multiple attempts entering |
| | | and or leaving the company. |
| Multiple failed Shell | 4 | Detected multiple failed shell attempts. |
| access attempts | | Detection should focus on failed |
| | | attempts entering and or leaving the |
| | | company |
| Peer-to-Peer File | 4 | Detected requests or access of files, |
| Activity | | utilizing peer-to-peer applications. |
| Unauthorized | 4 | Detected unauthorized operating system |
| Operating System | | root activity associated with malicious |
| Root Access | | intruders. Detection should focus on |
| | | activity in which the source is unknown. |
| Transmission of | 4 | Detected transmission of keystroke |
| data collected from | | logging application output. Detection |
| a Keystroke | | should focus on application results |
| Logging application | | leaving the company. |

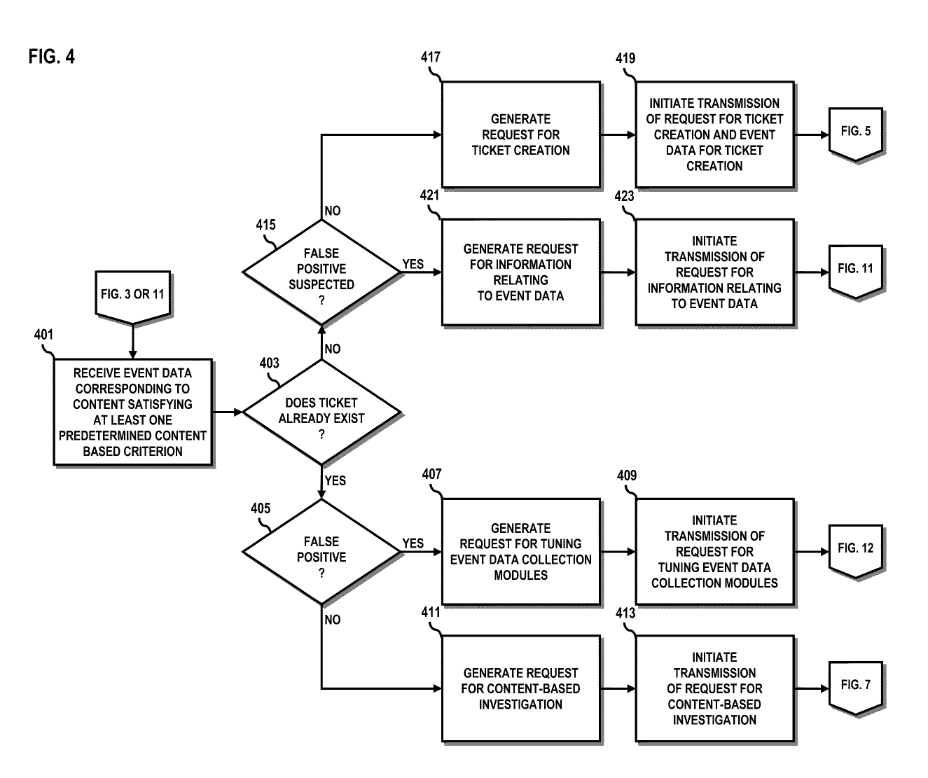

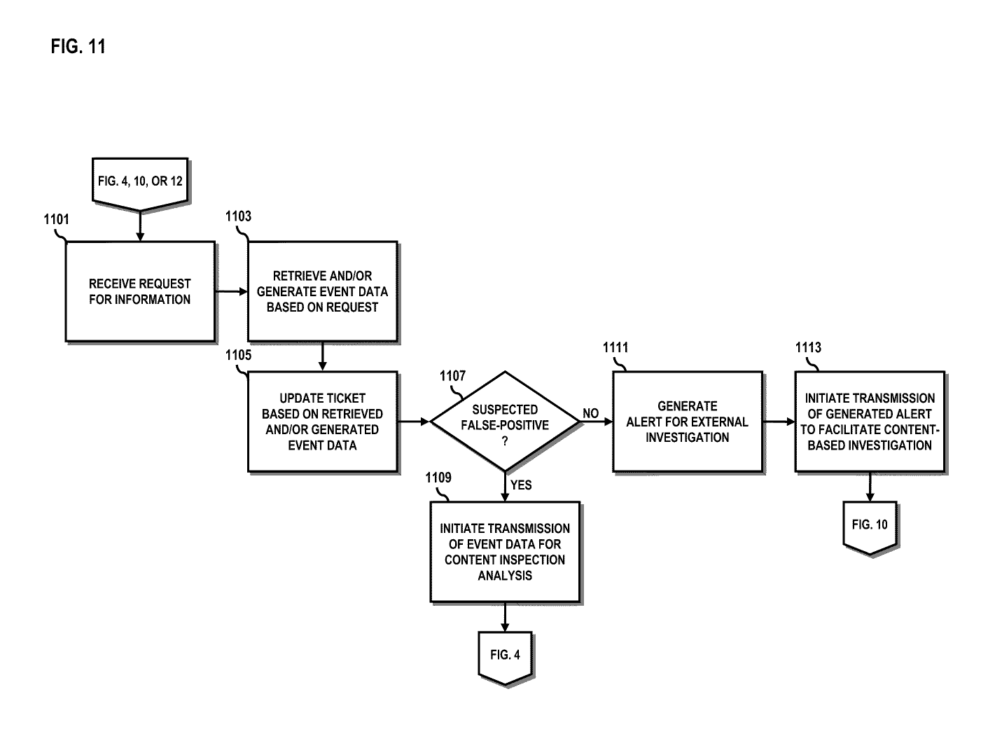

FIG. 4 is a flowchart of a process to facilitate content-based investigation services, according to an exemplary embodiment. For illustrative purposes, the process is described with respect to FIGS. 1 and 2. It is noted that the steps of the process may be performed in any suitable order or combined in any suitable manner. According to certain embodiments, after event data corresponding to content satisfying at least one predetermined content-based criterion is generated as, for example, explained earlier in accordance with the process of FIG. 3, the event data is analyzed to determine necessary actions needed. In step 401, the generated event data (as explained, for example, earlier in accordance to the process of FIG. 3) and/or an updated event data (as explained, for example, later in accordance with the process of FIG. 11) is received for inspection. According to certain embodiments, the event data can be received at the platform 101 and/or the ticket system 113. For example, the event data (generated and/or updated) can be retrieved from the event data database 121.

In step 403, a determination is made whether a ticket for the event data already exists. According to certain embodiments, the ticket can include categorized and organized information associated with the event data and can be used to maintain workflow elements such as, but not limited to, status, escalation, and notification. In one example, determining whether a ticket already exists for the suspected content-based violation can include initiating a search on the ticket data database 115 of FIG. 1 based, at least in part, on information included in the event data. In one embodiment, the determination in step 403 can avoid duplication an existing ticket.

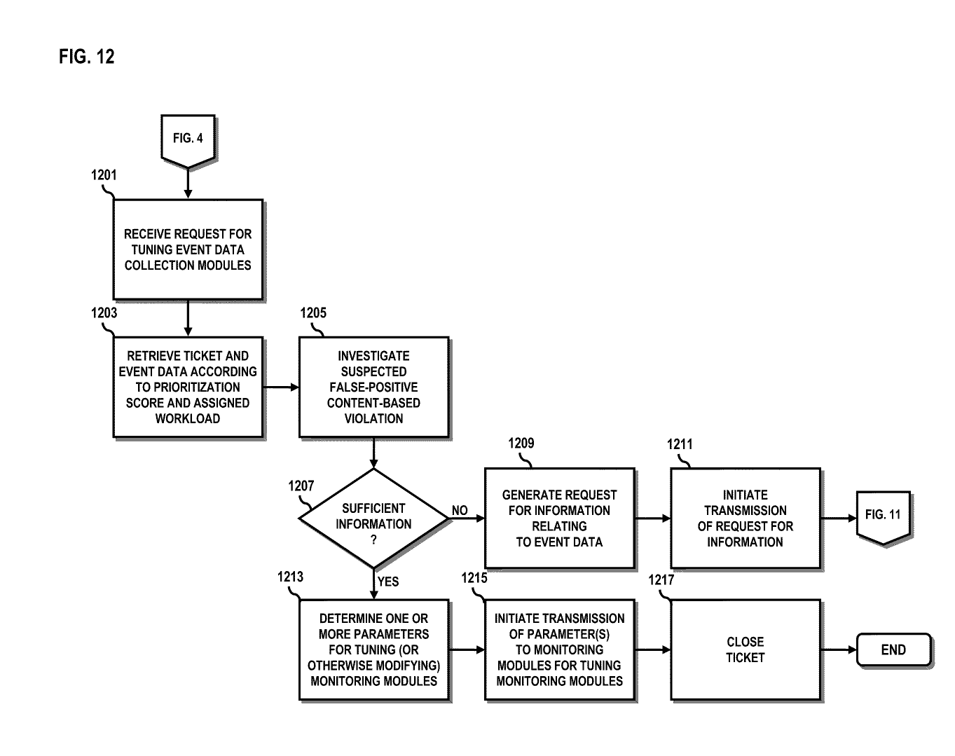

If the process, per step 403, determines that a ticket already exists for the event data, at step 405 it is determined whether the generated and/or the updated event data is a false positive. According to an exemplary embodiment, the false-positive ticket can correspond to an event and/or an incident that is not of a value or a desired result. In one example, the false positive determination of the event data can be based, at least in part, on the information collected for the event data. Accordingly, if it is determined that the event data corresponds to a false positive, in steps 407 and 409, a request is generated and transmitted for tuning monitoring and collection modules. According to certain embodiments, the generated tuning request can be transmitted to the monitored networking environment 111 for tuning monitoring modules 103a-103n and/or nodes 105a-109n of FIG. 1. In one example, the process of modifying one or more content-based monitoring parameters in response to determining that particular event data relates to a false positive (suspected content-based violation) is explained in more details below in accordance with FIG. 12.

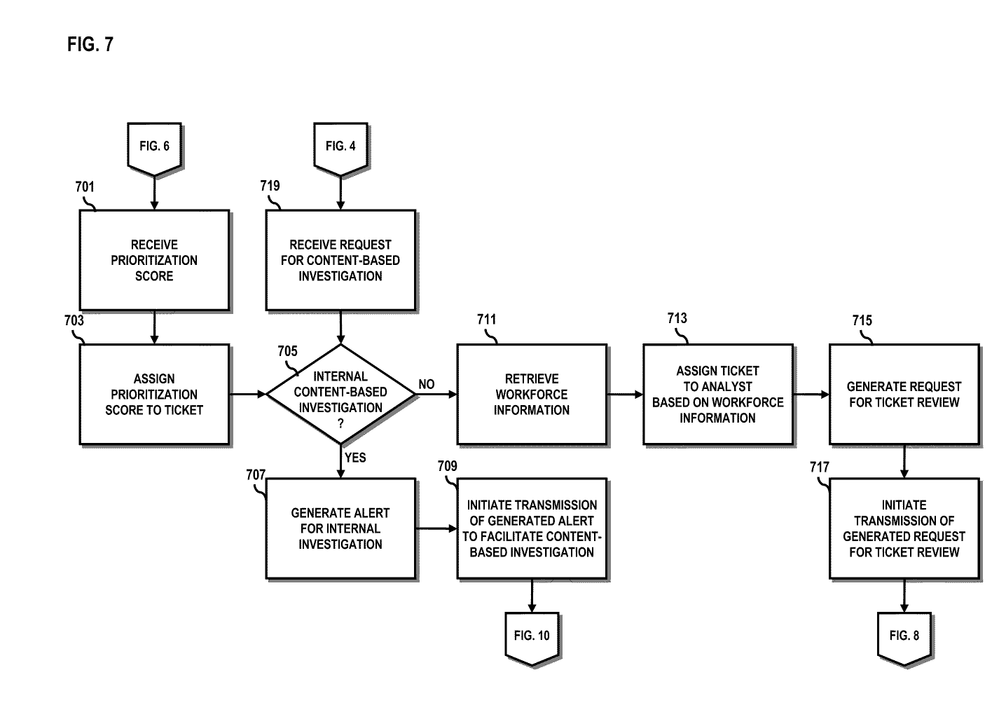

However, if, at step 405, it is determined that the generated and/or updated event data corresponding to the suspected content-based violation is not a false positive, in steps 411 and 413 a request for content-based investigation of the event data is generated and transmitted. Accordingly, when the initial inspections determine that a ticket for the event data exists and the event data has a value and/or a desired result, the content-based investigation of the event data can be initiated. According to certain embodiment, a process for generating an alert for initiating investigation of a suspected content-based violation and/or generating a ticket review request is explained below in more detail with respect to FIG. 7.

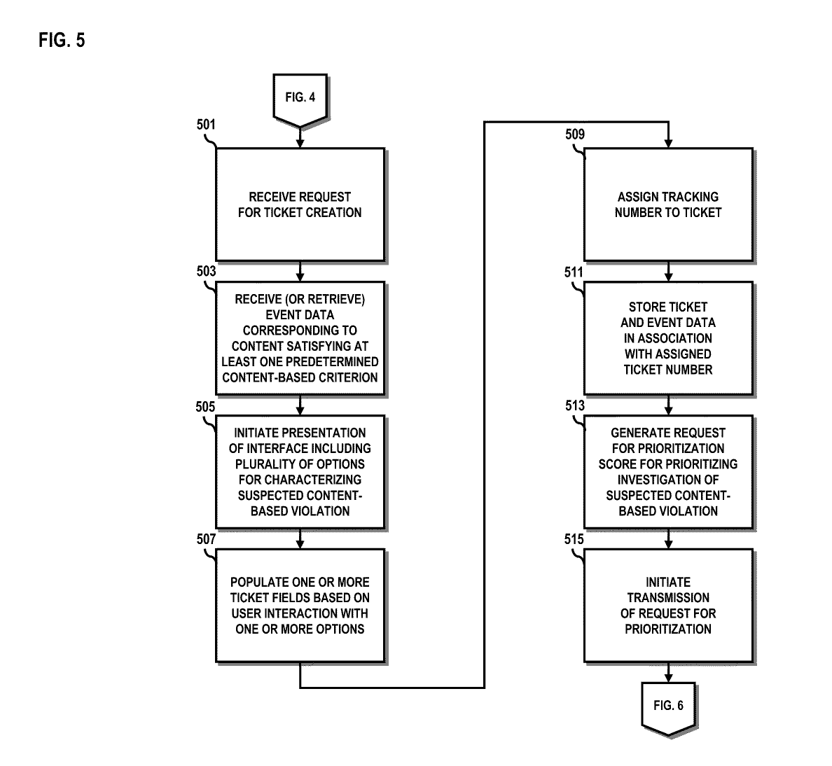

As previously described, when the generated and/or the updated event data is received, a determination is made in step 403 whether a ticket already exists for the event data. If it is determined that no ticket for the event data currently exists, a further determination is made whether the event data is a false positive, in step 415. If the received event data is not a false positive and a corresponding ticket does not exists, a request is generated and transmitted in steps 417 and 419 for creating a ticket associated with the event data. According to certain embodiments, the ticket creation request can be transmitted to the ticket system 113 of FIG. 1. Also, according to another example, the event data can be transmitted along with the ticket creation request. Alternatively or additionally, information regarding the event data database 121 of FIG. 1 where the event data is stored can be transmitted with the request. In one example, the process for generating a ticket corresponding to a suspected content-based violation is explained in more details with respect to FIG. 5.

However, if determinations 403 and 415 determine that a ticket does not exist for the event data and the event data is a suspected false positive, a request for information related to the event data is generated and transmitted in steps 421 and 423.

FIG. 5 is a flowchart of a process for generating a ticket corresponding to a suspected content-based violation, according to an exemplary embodiment. For illustrative purposes, the process is described with respect to FIGS. 1 and 2. It is noted that the steps of the process may be performed in any suitable order or combined in any suitable manner.

In step 501, a request for creating a ticket for corresponding to the event data is received. According to an exemplary embodiment, the request can be received at the ticket system 113 of FIG. 1 such that the ticket system 113 in communication with the content inspection platform can generate a ticket that can, for example, maintain workflow elements, such as status, escalation, notification, etc., for the suspected content-based violation. In step 503, the event data corresponding to the suspected content-based violation can be received or retrieve. According to certain embodiments, the event data, which corresponds to content satisfying the at least one predetermined content-based criterion is received with the request to generate the ticket. Additionally or alternatively, the event data can be retrieved from, for example, a database, such as the event data database 121 of FIG. 1. The event data can be used in creation of the ticket.

According to certain embodiments, in step 505, presentation of a user interface (UI) can be initiated. For example, the UI can include one or more options that can be used by a user of the UI to characterize the suspected content-based violation in creation of the ticket. According to certain embodiments, the UI can be used to describe details associated with the incident. For example, these details can determine location information regarding the suspected content-based violation, such as, a network address (e.g., Internet Protocol (IP) address) of the suspected violator(s), IP address of suspected destination of the violation, etc. Additionally or alternatively, the ticket details characterizing the event and/or incident can include timing information associated with the suspected content-based violation (such as when the different events occurred) and information regarding the suspected violator (such as identification information, username, email address, etc.). Further, according to certain embodiments, the UI can be used to determine detailed discussion regarding the suspected content-based violation, information regarding policies violated by the event, any attachments, etc.

In step 507, one or more fields associated with the ticket can be populated based, at least in part, on the information created by the UI, the received and/or retrieved event data, etc. In step 509, a tracking number can be generated and assigned to the ticket. The tracking number and/or the ticket number can be used for storage and references needs, to maintain the workflow of the ticket, to assign new events, etc. The created ticket including detailed information of the suspected content-based violation can be stored in step 511 according to the ticket number. In one embodiment, the ticket can be stored in the ticket data database 115.

In step 513, a request is generated for a prioritization score for the ticket generated for the suspected content-based violation. According to certain embodiments, the prioritization score can be used for prioritizing investigation of the suspected content-based violation. In step 515, the generated prioritization request is transmitted.

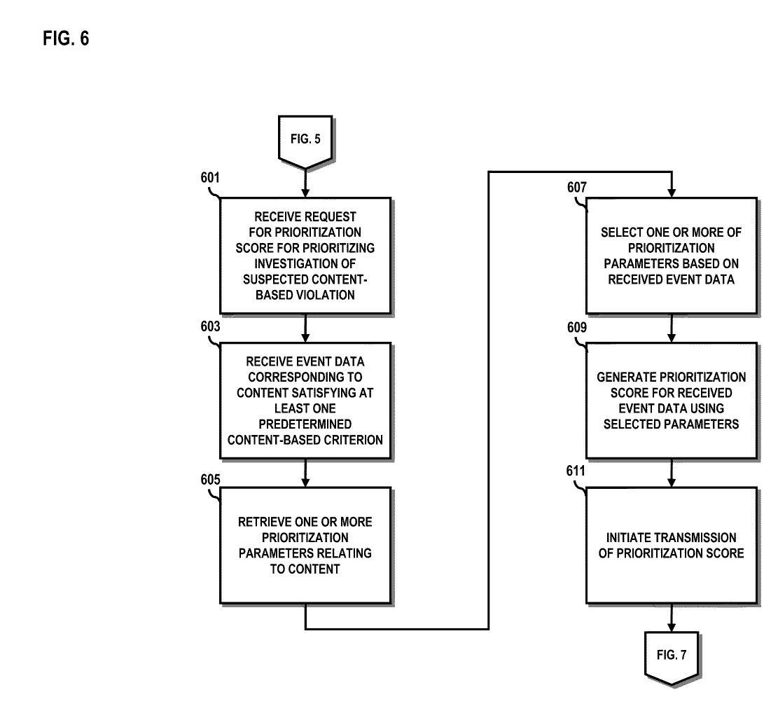

FIG. 6 is a flowchart of a process for generating a prioritization score for scheduling investigation of a suspected content-based violation, according to an exemplary embodiment. For illustrative purposes, the process is described with respect to FIGS. 1 and 2. It is noted that the steps of the process may be performed in any suitable order or combined in any suitable manner.

According to certain exemplary embodiments, the prioritization score can be determined at the content inspection platform 101 in communication ticket system 113, event data database 121, and/or prioritization parameter database 123 of FIG. 1. In step 601, the request for generating the prioritization score is received. As discussed earlier, the prioritization score can be used for prioritizing investigation of suspected content-based violations. In one example, the prioritization score can be used in, for example, the content inspection platform 101 to determine which events and/or incidents have higher priority for investigation. According to one embodiment, information related to the event and/or incident can be used to determine the prioritization score. This information can be included in the ticket associated with the event. In step 603, the information associated with the event is received and/or retrieved. The event information can correspond to the content satisfying the at least one predetermined content-based criterion. According to one example, the event data can be retrieved from, for example, the event data database 121 and/or the ticket data database 115 of FIG. 1. Alternatively or additionally, the event data can be received along with the prioritization score request.

In step 605, one or more prioritization parameters are received based, at least in part, on the content. According to an exemplary embodiment, the prioritization parameter(s) are retrieved from the prioritization parameter database 123 of FIG. 1. In one example, the one or more prioritization parameters can be retrieved based, at least in part, on the at least one predetermined content-based criterion that the content satisfied. In step 607, one or more of the retrieved prioritization parameters are selected to be used to generate the prioritization score. According to an example, selection of one or more of the retrieved prioritization parameters can be based, at least in part, on the information received for the event (e.g., event data). This information can include information included in the ticket generated for the event, and the selection can be based on analysis of the information. In step 609, the prioritization score is generated for the event and/or the incident based on the selected prioritization parameters. The prioritization score, which can be used in determining investigation priority of events, can be determined based, at least in part, on a weighted calculations based on the selected prioritization parameters. Table 5 illustrates an exemplary prioritization schedule that can be used in determining the prioritization parameters, selecting the prioritization parameters, and/or determining the prioritization score. In step 611, the generated prioritization score is transmitted.

TABLE 5
Exemplary Prioritization Schedule

| Priority Category 1 | | Source Examples | | |
|---|---|---|---|---|
| Critical: Initial Default Rating = 60 | | Active Employee | 2 | □ |
| □ | Business Support Category | External Vendor | 4 | □ |
| □ | Proprietary Source Code | Competitor | 10 | □ |
| | COBOL | Senior Management | 10 | □ |
| | C and C++ | Internal | 5 | □ |
| | Perl | External | 2 | □ |
| | Visual Basic | Source Rating = | | |
| □ | Proprietary or Sensitive Information sent via | | | |
| | Webmail | | | |
| □ | Unauthorized vulnerability assessment scan | Target Examples | | |
| □ | Unauthorized packet sniffer | Employee | 2 | □ |
| □ | Server and Web Vulnerability Exploitation tool | External Vendor | 5 | □ |
| □ | Password Crackers and Brute force attacks | Competitor | 10 | □ |
| □ | Windows Operating System Enumeration tools | Senior Management | 10 | □ |
| □ | Unauthorized installation of Operation System | Internal | 4 | □ |
| | backdoor tools | External | 6 | □ |
| Priority Category 2 | | Target Rating = | | |
| High: Initial Default Rating = 40 | | Contributing Factor Examples | | |
| □ | Unauthorized access or transmission of Credit Card | Embargoed Nation | 15 | □ |
| | Information | | | |
| □ | Unauthorized access or transmission of Personally | Third Party Vendor | 2 | □ |
| | Identifiable Information (PII) | | | |
| □ | Unauthorized access or transmission of Federal | City Level Offense | 3 | □ |
| | Social Security Numbers | State Level Offense | 4 | □ |
| | | Federal Level Offense | 10 | □ |
| | | Attachment Sent | 10 | □ |
| Priority Category 3 | | Multiple Victims | 3 | □ |
| Medium: Initial Default Rating = 20 | | Multiple Suspects | 4 | □ |
| □ | Access of Pornographic content | Repeat Offender | 5 | □ |
| □ | Unauthorized Proxy Use | Multi-BU Impact | 10 | □ |
| | | Contingent Worker | 3 | □ |
| Priority Category 4 | | Habitual Use | 5 | □ |
| Low: Initial Default Rating = 0 | | | | |
| □ | Multiple Failed FTP access attempts | Life Safety Issue | 50 | □ |
| | | Traffic Volume >1 | 1 | □ |
| □ | Multiple Failed Shell access attempts | Traffic Volume >3 | 2 | □ |
| | | Traffic Volume >100 | 3 | □ |
| □ | Peer-to-Peer File Activity | Exploited Vulnerability | 10 | □ |
| | | Immediate Threat | 50 | □ |
| □ | Unauthorized Operating System Root Access | Contributing Factors | | |
| | | Rating = | | |

| □ | Transmission of data collected from a Keystroke | Incident Prioritization Ratings |
|---|---|---|
| | Logging application | Initial Default Rating |
| | | Source Rating |
| | | Target Rating |
| | | Contributing Factor Rating |

Incident Prioritization Score
Prioritization Score =

FIG. 7 is a flowchart of a process for generating an alert for initiating investigation of a suspected content-based violation and/or generating a ticket review request, according to an exemplary embodiment. For illustrative purposes, the process is described with respect to FIGS. 1 and 2. It is noted that the steps of the process may be performed in any suitable order or combined in any suitable manner.

According to certain exemplary embodiments, generating investigation alerts and/or review request can occur in the ticket system 113 in communication with the platform 101 of FIG. 1. In step 701, the prioritization score, as generated, for example, according to FIG. 6, is received. As mentioned, the prioritization score can be used to indicate the priority of a ticket, event, and/or incident for investigation. In step 703, the received prioritization score is assigned to the ticket, for which it was generated. As discussed, the ticket can be generated according to the process of FIG. 5, and the prioritization score can be determined in, for example, a field of the ticket.

In step 705, a determination is made whether the ticket is ready for content-based investigation. In one example, the determination can be made based, at least in part, on whether necessary reviews (if any required) of the ticket are performed. If it is determined that the ticket is ready for internal content-based investigation, in step 707, an alert for internal investigation is generated and in step 709, the generated alert is transmitted for internal content-based investigation. In one example, the generated alert can include the ticket containing necessary information to investigate the event. Alternatively or additionally, the generated alert message can include, for example, a pointer indicating an address where the ticket can be retrieved. According to certain embodiments, the ticket can be a part of an incident report.

However, if in step 705, it is determined that internal content-based investigation is not appropriate at this time, a ticket review request can be generated and transmitted according to, for example, steps 711 through 717, as described below. In step 711, workforce information associated, for example, to the ticket is retrieved. According to an exemplary embodiment, the workforce information can be retrieved using workforce system 117 and/or workforce data database 119 of FIG. 1. In on example, the workforce information can include information regarding one or more entities, authorities, etc., that generated the ticket and/or can review the ticket information. In step 713, the ticket is assigned to an analyst based on the retrieved information. In step 715, a request to review the ticket is generated and in step 717, the generated request is transmitted to the appropriate entity, authority, etc., to perform ticket review. According to one exemplary embodiment, one the ticket is generated and the analyst ensured that all ticket requirements are satisfied; the review process is initiated so that the quality and content of the ticket (and/or incident report) is inspected.

It is noted that although the initiation of the ticket review request and/or internal investigation is discussed above in reference to a generated ticket, it is contemplated that the ticket review request and/or internal investigation can also be initiated when a request for content-based investigation is received. According to this exemplary embodiment, in step 719 a request for content-based investigation is received, and in step 705 it is determined whether an internal content-based investigation is appropriate. If appropriate, the internal content-based investigation alert is generated and transmitted in steps 707 and 709. Otherwise, a request for review is initiated and transmitted in steps 711 through 717.

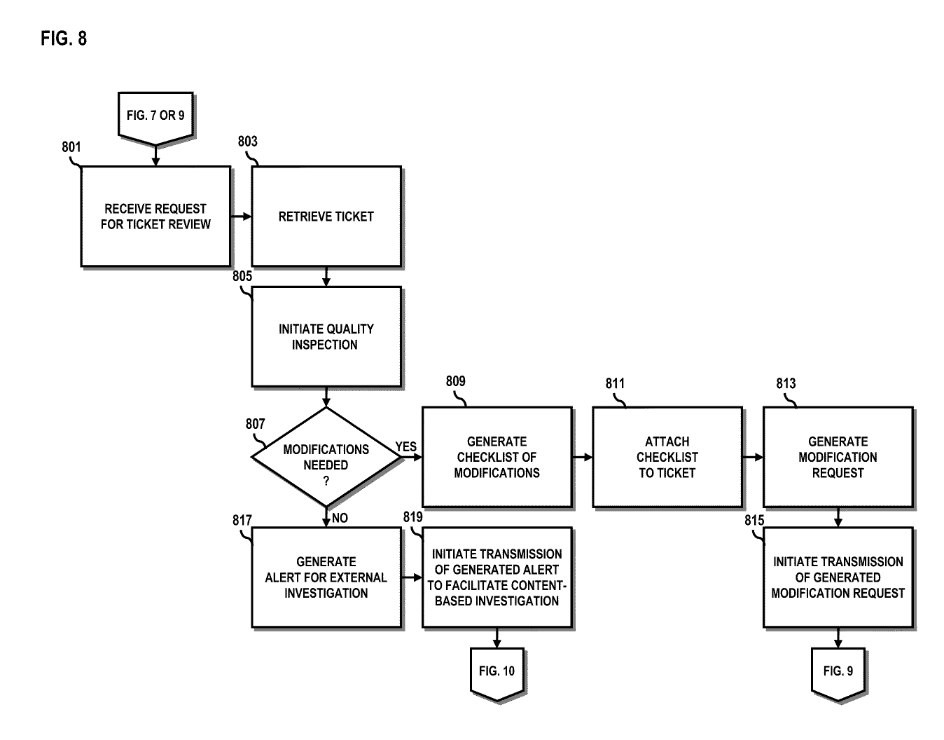

FIG. 8 is a flowchart of a process for reviewing a ticket and/or generating an alert for initiating investigation of a suspected content-based violation, according to an exemplary embodiment. For illustrative purposes, the process is described with respect to FIGS. 1 and 2. It is noted that the steps of the process may be performed in any suitable order or combined in any suitable manner.

In step 801, a request is received to review a ticket. According to certain embodiment, the review request can be received at the platform 101. An entity, an authority, etc., such as a reviewer can be assigned to review the quality and content of the ticket (and/or incident report). According to certain embodiment, the request for review can be stored in a queue. The order in which the review request are stored and/or reviewed can be based, at least in part, on certain characteristics of the requested tickets. For example, the tickets with escalated importance are reviewed first. Also, according to another example, tickets with oldest and/or highest priorities (which can be determined based on prioritization scores) are reviewed next. In step 803, the ticket, for which the review request is received, is retrieved. According to an example, the ticket can be retrieved using the ticket system 113 from, for example, the ticket data database 115. Additionally or alternatively, the received request can include the ticket.

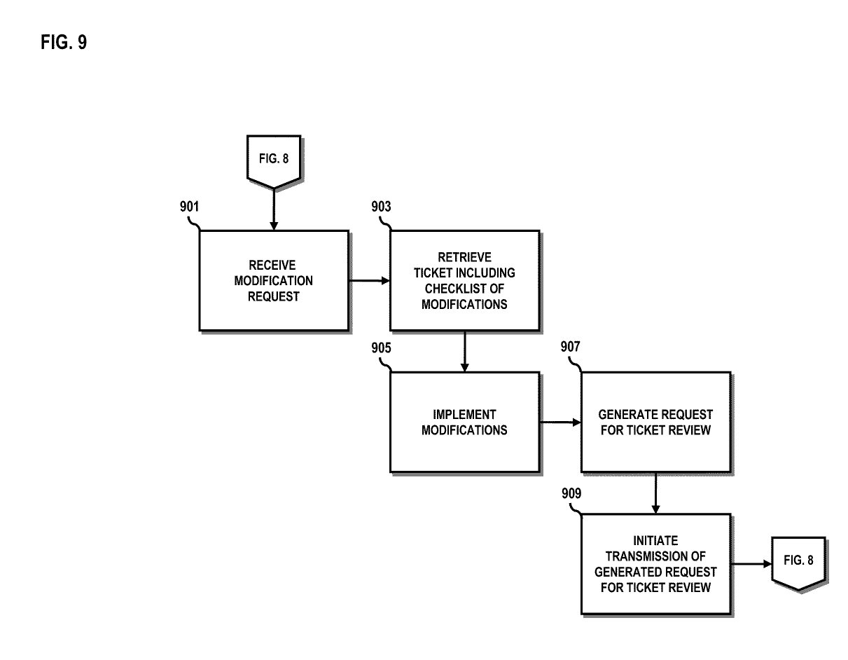

In step 805, the quality inspection of the ticket is initiated. According to certain embodiments, the quality inspection can include, but not limited to, determining whether all necessary fields of the tickets are filled, determining the quality of information of the ticket, etc. In step 807, a determination is made whether any modification to the ticket is necessary. If the review indicates that revisions for the ticket is needed, in step 809 a checklist is generated that indicates needed modifications. In one example, the checklist can assist with the process of ticket revision. In steps 811 through 815, the generated checklist is attached to the ticket, a modification request is generated, and the generated modification request is transmitted for necessary revisions. According to certain embodiments, the ticket (with the generated checklist) can be transmitted with the generated modification request. Alternatively or additionally, the ticket with the checklist can be stored in, for example, the ticket data database 115 of FIG. 1 and can be further retrieved for the revision process. The revision process can be performed according, for example, to FIG. 9 as explained below. As shown below with respect to FIG. 9, the review and revision process can be repeated. The review and revision process can terminate, for example, based on, at least in part, a number of occurrences of the repeat, if a quality performance measure is satisfied (or not satisfied). Also, according to certain embodiments, the process of review and revision can include different levels, which can include different entities, authorities, etc.

However, if the process in step 807 determines that no modifications are needed for the ticket, in steps 817 through 819, an alert for external investigation can be generated and the alert can be transmitted for external content-based investigation. In one example, the external investigation request can include the ticket.

FIG. 9 is a flowchart of a process for modifying a ticket based on results of a ticket review, according to an exemplary embodiment. For illustrative purposes, the process is described with respect to FIGS. 1 and 2. It is noted that the steps of the process may be performed in any suitable order or combined in any suitable manner.

In step 901, a modification request is received that indicates revisions needed for the ticket. According to an exemplary embodiment, the modification request can be received at the platform 101 and/or the ticket system 113 of FIG. 1. As discussed, the process of review and revision can occur at different levels of authorities, entities, etc. In step 903, the ticket and the checklist assigned to the ticket are retrieved. According to certain embodiments, the modification request can include the ticket for which the revision is requested. Alternatively or additionally, the modification request can include information regarding the ticket that assists in retrieving the ticket from, for example, the ticket data database 115 of FIG. 1. In step 905, needed revisions are performed on the ticket based, at least in part, the checklist assigned to the ticket.

According to certain embodiments, the revised ticket needs to be reviewed again to ensure that, for example, the modifications are correctly applied. Therefore, in steps 907 and 909, a request for ticket review is generated and transmitted for another round of review. According to certain embodiments, the review can be performed in accordance with the process of FIG. 8, as explained earlier.

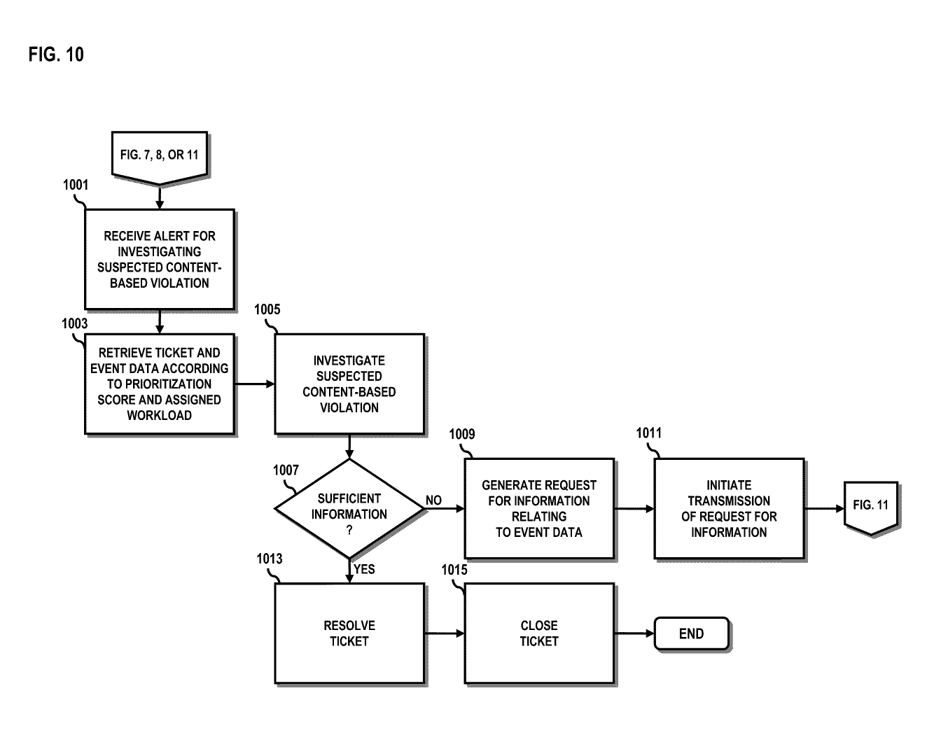

FIG. 10 is a flowchart of a process for requesting more information concerning a suspected content-based violation and/or closing a ticket associated with the suspected content-based violation, according to an exemplary embodiment. For illustrative purposes, the process is described with respect to FIGS. 1 and 2. It is noted that the steps of the process may be performed in any suitable order or combined in any suitable manner.

According to certain exemplary embodiments, when a ticket and/or an incident report is generated, its prioritization score is assigned, and/or is reviewed, it is reviewed. In one example, in step 1001, an alert is received for investigating a suspected content-based violation. The investigation alert can be generated according to one or more processes of FIGS. 7, 8, and/or 11. In step 1003, the ticket and event data according, at least in part, to prioritization score and assigned workload for the suspected content-based violation is retrieved. According to an exemplary embodiment, the ticket associated with the suspected violation can be retrieved from the ticket system 113 and/or the ticket data database 115 of FIG. 1. In another example, the event data associated with the suspected violation can be retrieved from the event data database 121 of FIG. 1. Additionally or alternatively, the received investigation alert can include the ticket and/or the event data.

In step 1005, the suspected content-based violation is investigated. In one example, the investigation of the suspected violation is based, at least in part, on the information included in the retrieved ticket and/or the retrieved event data. This investigation can determine next steps on the ticket and or event data associated with the suspected content-based violation. In step 1007, a determination is made based, at least in part, on the investigation of the suspected violation; whether the ticket and/or the event data include sufficient information to, for example, make a decision on the suspected violation. If it is determined that information included in the ticket and/or the event data is not sufficient, in steps 1009 and 1011 a request for more information relating to the suspected violation is generated and transmitted. According to certain embodiments, the generated request for more information can be sent to the monitored networking environment 111 to collect more information related to the suspected violation. Additionally or alternatively, the request for more information can be sent to entities, authorities (such as analysts, reviewers), etc., to provide more information related to the suspected violation. The process for more information can be performed in accordance with FIG. 11, as explained below.

However, if in step 1007 it is determined that the retrieved ticket and/or event data has sufficient information regarding the suspected content-based violation, in step 1013, the ticket is resolved. In one example, resolving the ticket can include making a determination, based, at least in part, on the ticket and/or event data, that incident is not significant enough. Alternatively, resolving the ticket can include taking necessary actions necessitated by the information presented by the ticket and/or event data. The resolved ticket will be closed in step 1015. According to certain embodiment, closing the ticket can include preparing and assigning (to the ticket) a reason to close the ticket and further storing the closed ticket in, for example, the ticket data database 115 of FIG. 1.

FIG. 11 is a flowchart of a process for updating a ticket associated with a request for more information concerning a suspected content-based violation, according to an exemplary embodiment. For illustrative purposes, the process is described with respect to FIGS. 1 and 2. It is noted that the steps of the process may be performed in any suitable order or combined in any suitable manner.

In step 1101, a request for more information is received. According to certain embodiments, the request for more information can be generated according to one or more processes of FIGS. 4, 10, and/or 12. In one example, the request for more information can be received at the platform 101, which can be further communicated to the monitored networking environment 111 and/or entities, authorities, etc. in charge of collecting and/or providing information regarding a suspected content-based violation. According to an exemplary embodiment, the received request can determine the needed information. In step 1103, information needed for the ticket and/or event data can be generated based, at least in part, on the received request. Additionally or alternatively, the needed information can be retrieved from, for example, the event data database 121.

In step 1105, the generated and/or retrieved event data is used to update the ticket based, at least in part, on the received request for more information. According to certain embodiments, the updated ticket can be stored in, for example, the ticket data database 115. In step 1107, a determination is made whether the update ticket represents a suspected false-positive. According to an exemplary embodiment, the false-positive ticket can correspond to an event and/or an incident that is not of a value or a desired result. If it is determined that the updated ticket represent a suspected false-positive, the ticket and/or the event data is transmitted for content inspection analysis, which, according to certain embodiments, can be performed in accordance with the process of FIG. 4.

However, if it is determined that the ticket and/or the event data is not a suspected false-positive, in steps 1111 and 1113 an alert message is generated and transmitted for external content-based investigation of the ticket. The content-based investigation of the updated ticket and/or event data can be further performed in accordance with the process of FIG. 10, as discussed earlier.

FIG. 12 is a flowchart of a process for modifying one or more content-based monitoring parameters in response to determining that particular event data relates to a false-positive suspected content-based violation, according to an exemplary embodiment. For illustrative purposes, the process is described with respect to FIGS. 1 and 2. It is noted that the steps of the process may be performed in any suitable order or combined in any suitable manner.

According to certain embodiments, in step 1201, a request for tuning event data collection modules is received when it is determined that a particular event data relates to a false-positive suspected content-based violation, as, for example, in FIG. 4. According to an exemplary embodiment the tune request can be received at the ticket system 113. Requests generated based on the false-positive suspected content-based violation are used to identify, report, and tune for events and/or incidents that are determined to have no value and/or have no desired result. According to an exemplary embodiment, the received request can initiate an alert notice indicating receipt of the request. Alternatively or additionally, the received requests can be stored in a memory, a database, etc. In this example, the received tuning requests can be stored in a queue that contains the received request. In step 1203, the ticket and the event data according to prioritization scored and the assigned workload associated with the false-positive suspected content-based violation is retrieved. According to one example, the retrieved information can include information offering description of the false-positive suspected content-based violation. Alternatively or additionally, the retrieved information can include information regarding investigations performed for the false-positive suspected content-based violation. This information can be used to tune, for example, the collection modules.

In step 1205, an investigation on the false-positive suspected content-based violation is initiated. In one example, the investigation can be used to determine whether sufficient information for tuning the collection module exists in the tuning request and information retrieved based on the tuning request. In one example, investigating the false-positive suspected content-based violation can include ensuring that all necessary details are identified to carry out a specific result, ensuring that all the information are correct and specific details unique to the tune are included. According to certain embodiment, the investigation of the false-positive suspected content-based violation can include determining events, incidents, cases, etc., similar to the false-positive suspected content-based violation. For example, the retrieved information regarding the false-positive suspected content-based violation can be used to initiate a search to determine events, incidents, cases, etc., with possible common data.

In step 1207, it is determined whether the sufficient information is available. If information retrieved based on the tuning request is not sufficient, in step 1209, a request is generated to demand for more information relating to the event data, and in step 1211, this request it transmitted. In one example, this request can include information that is needed to complete the tuning However, if it is determined that the retrieved information is sufficient to tune the collection modules, in step 1213, one or more parameters for tuning and/or modifying the monitoring modules 103a-103n of FIG. 1 is determined. In step 1215, a request for tuning and/or modifying the parameters of the monitoring modules 103a-103n is generated based on the determination and is transmitted to the monitoring modules 103a-103n. In step 1217, the ticket is closed.

The described processes, according to certain embodiments, advantageously provide an efficient approach to examining content, whereby violations can be rapidly identified and resolved. An effective prioritization mechanism is employed for the identification. Such inspection can be integrated with a trouble ticketing system for expedient resolution.

The processes described herein for providing content-based investigation services may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

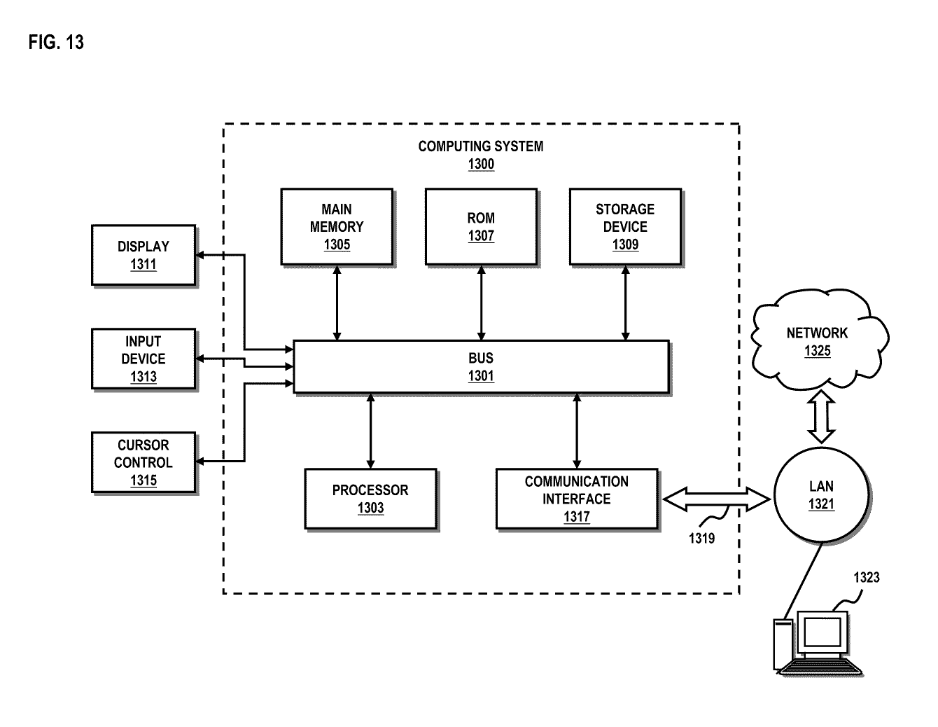

FIG. 13 illustrates computing hardware (e.g., computer system) 1300 upon which exemplary embodiments can be implemented. The computer system 1300 includes a bus 1301 or other communication mechanism for communicating information and a processor 1303 coupled to the bus 1301 for processing information. The computer system 1300 also includes main memory 1305, such as a random access memory (RAM) or other dynamic storage device, coupled to the bus 1301 for storing information and instructions to be executed by the processor 1303. Main memory 1305 can also be used for storing temporary variables or other intermediate information during execution of instructions by the processor 1303. The computer system 1300 may further include a read only memory (ROM) 1307 or other static storage device coupled to the bus 1301 for storing static information and instructions for the processor 1303. A storage device 1309, such as a magnetic disk or optical disk, is coupled to the bus 1301 for persistently storing information and instructions.

The computer system 1300 may be coupled via the bus 1301 to a display 1311, such as a cathode ray tube (CRT), liquid crystal display, active matrix display, or plasma display, for displaying information to a computer user. An input device 1313, such as a keyboard including alphanumeric and other keys, is coupled to the bus 1301 for communicating information and command selections to the processor 1303. Another type of user input device is a cursor control 1315, such as a mouse, a trackball, or cursor direction keys, for communicating direction information and command selections to the processor 1303 and for controlling cursor movement on the display 1311.

According to an exemplary embodiment, the processes described herein are performed by the computer system 1300, in response to the processor 1303 executing an arrangement of instructions contained in main memory 1305. Such instructions can be read into main memory 1305 from another computer-readable medium, such as the storage device 1309. Execution of the arrangement of instructions contained in main memory 1305 causes the processor 1303 to perform the process steps described herein. One or more processors in a multi-processing arrangement may also be employed to execute the instructions contained in main memory 1305. In alternative embodiments, hard-wired circuitry may be used in place of or in combination with software instructions to implement exemplary embodiments. Thus, exemplary embodiments are not limited to any specific combination of hardware circuitry and software.

The computer system 1300 also includes a communication interface 1317 coupled to bus 1301. The communication interface 1317 provides a two-way data communication coupling to a network link 1319 connected to a local network 1321. For example, the communication interface 1317 may be a digital subscriber line (DSL) card or modem, an integrated services digital network (ISDN) card, a cable modem, a telephone modem, or any other communication interface to provide a data communication connection to a corresponding type of communication line. As another example, communication interface 1317 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1317 sends and receives electrical, electromagnetic, or optical signals that carry digital data streams representing various types of information. Further, the communication interface 1317 can include peripheral interface devices, such as a Universal Serial Bus (USB) interface, a PCMCIA (Personal Computer Memory Card International Association) interface, etc. Although a single communication interface 1317 is depicted in FIG. 13, multiple communication interfaces can also be employed.

The network link 1319 typically provides data communication through one or more networks to other data devices. For example, the network link 1319 may provide a connection through local network 1321 to a host computer 1323, which has connectivity to a network 1325 (e.g. a wide area network (WAN) or the global packet data communication network now commonly referred to as the “Internet”) or to data equipment operated by a service provider. The local network 1321 and the network 1325 both use electrical, electromagnetic, or optical signals to convey information and instructions. The signals through the various networks and the signals on the network link 1319 and through the communication interface 1317, which communicate digital data with the computer system 1300, are exemplary forms of carrier waves bearing the information and instructions.

The computer system 1300 can send messages and receive data, including program code, through the network(s), the network link 1319, and the communication interface 1317. In the Internet example, a server (not shown) might transmit requested code belonging to an application program for implementing an exemplary embodiment through the network 1325, the local network 1321 and the communication interface 1317. The processor 1303 may execute the transmitted code while being received and/or store the code in the storage device 1309, or other non-volatile storage for later execution. In this manner, the computer system 1300 may obtain application code in the form of a carrier wave.

The term “computer-readable medium” as used herein refers to any medium that participates in providing instructions to the processor 1303 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 1309. Volatile media include dynamic memory, such as main memory 1305. Transmission media include coaxial cables, copper wire and fiber optics, including the wires that comprise the bus 1301. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

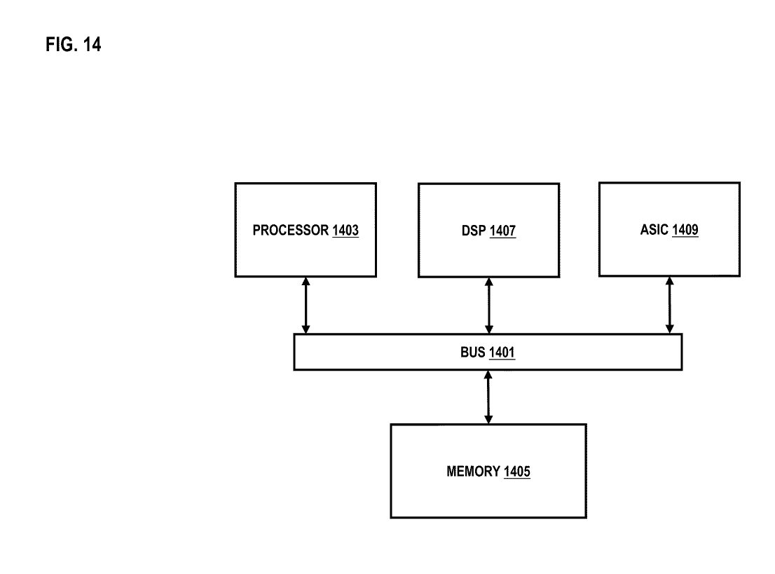

FIG. 14 illustrates a chip set 1400 upon which an embodiment of the invention may be implemented. Chip set 1400 is programmed to present a slideshow as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1400, or a portion thereof, constitutes a means for performing one or more steps of FIGS. 2, 6, 7, and 9A-9D.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to presenting a slideshow via a set-top box. The memory 1405 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving event data corresponding to content satisfying a predetermined criterion;
retrieving a plurality of prioritization parameters relating to the content;
selecting one or more of the prioritization parameters based on the received event data;
generating a prioritization score for the event data using the selected parameters;
scheduling inspection of the event data according to the prioritization score; and
selectively determining whether the content is in violation according to the inspection.

2. A method according to claim 1, further comprising:
determining whether a ticket associated with the event data is available;
determining whether the event data is a false positive based on the determination that the ticket is unavailable; and
initiating creation of the ticket for the event data based on the determination that the event data is not a false positive.

3. A method according to claim 2, further comprising:
initiating presentation of one or more options relating to suspected content-based violation via a user interface;
receiving user data in response to selection of one or more of the options by a user;
creating a ticket associated with the event data based, at least in part, on the user data, the event data, or a combination thereof; and
assigning a tracking number to the generated ticket.

4. A method according to claim 3, further comprising:
assigning the prioritization score to the generated ticket associated with the event data.

5. A method according to claim 3, further comprising:
determining whether the ticket, the event data, or a combination thereof specifies sufficient information to determine the violation;
generating a request for additional information for transmission to a monitoring system to collect the additional information; and
updating the ticket based on the collected additional information.

6. A method according to claim 1, further comprising:
receiving a tuning request, wherein the tuning request is based, at least in part, on a determination that the event data is a false positive;
determining modification value for one or more tuning parameters; and
initiating transmission of the modification value of the one or more tuning parameters.

7. An apparatus comprising:
at least one processor; and
at least one memory including computer program code,
the at least one memory and the computer program code configured to, with the at least one processor, cause the apparatus to perform at least the following,
receive event data corresponding to content satisfying a predetermined criterion;
retrieve a plurality of prioritization parameters relating to the content;
select one or more of the prioritization parameters based on the received event data;
generate a prioritization score for the event data using the selected parameters;
schedule inspection of the event data according to the prioritization score; and
selectively determine whether the content is in violation according to the inspection.

8. An apparatus according to claim 7, wherein the processor is further configured to:
determine whether a ticket associated with the event data is available;
determine whether the event data is a false positive based on the determination that the ticket is unavailable; and
initiate creation of the ticket for the event data based on the determination that the event data is not a false positive.

9. An apparatus according to claim 8, wherein the apparatus is further caused, at least in part, to:
initiate presentation of one or more options relating to suspected content-based violation via a user interface;
receive user data in response to selection of one or more of the options by a user;
create a ticket associated with the event data based, at least in part, on the user data, the event data, or a combination thereof; and
assign a tracking number to the generated ticket.

10. An apparatus according to claim 9, wherein the apparatus is further caused, at least in part, to:
assign the prioritization score to the generated ticket associated with the event data.

11. An apparatus according to claim 9, wherein the apparatus is further caused, at least in part, to:
determine whether the ticket, the event data, or a combination thereof specifies sufficient information to determine the violation;
generate a request for additional information for transmission to a monitoring system to collect the additional information; and
update the ticket based on the collected additional information.

12. An apparatus according to claim 7, wherein the apparatus is further caused, at least in part, to:
receive a tuning request, wherein the tuning request is based, at least in part, on a determination that the event data is a false positive;
determine modification value for one or more tuning parameters; and
initiate transmission of the modification value of the one or more tuning parameters.

13. A system comprising:
a monitoring module configured to collect event data corresponding to content satisfying a predetermined criterion; and
a content inspection platform configured to receive the event data and to generating a prioritization score based on a plurality of prioritization parameters relating to the content,
wherein an inspection of the event data is scheduled according to the prioritization score, and the content inspection platform is further configured to selectively determine whether the content is in violation according to the inspection.

14. A system according to claim 13, wherein the content inspection platform is further configured to determine whether a ticket associated with the event data is available, to determine whether the event data is a false positive based on the determination that the ticket is unavailable, and to initiate creation of the ticket for the event data based on the determination that the event data is not a false positive.

15. A system according to claim 14, further comprising:
a portal configured to communicate with the content inspection platform and to present one or more options relating to suspected content-based violation via a user interface, wherein the portal is further configured to receive user data in response to selection of one or more of the options by a user.

16. A system according to claim 14, further comprising:
a ticket system configured to communicate with the content inspection platform and to create a ticket associated with the event data based, at least in part, on the user data, the event data, or a combination thereof, wherein the ticket system is further configured to assign a tracking number to the generated ticket.

17. A system according to claim 16, wherein the content inspection platform is further configured to assign the prioritization score to the generated ticket associated with the event data.

18. A system according to claim 16, wherein the content inspection platform is further configured to determine whether the ticket, the event data, or a combination thereof specifies sufficient information to determine the violation; and to generate a request for additional information for transmission to a monitoring system to collect the additional information, wherein the ticket system is further configured to update the ticket based on the collected additional information.

19. A system according to claim 16, further comprising:
a workforce system configured to assign an analyst to the generated ticket.

20. A system according to claim 13, wherein the content inspection platform is further configured to receive a tuning request that is based, at least in part, on a determination that the event data is a false positive, to determine modification value for one or more tuning parameters; and to initiate transmission of the modification value of the one or more tuning parameters.
